(19) United States
(12) Patent Application Publication
(10) Pub. No.: US 2010/0287026 A1
(43) Pub. Date: Nov. 11, 2010

(54) SYSTEM AND METHOD FOR PROVIDING ONLINE VIDEO ADVERTISEMENTS BASED ON DETERMINED USER TOLERANCES

(75) Inventor: Adam Smith, Seattle, WA (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: DISNEY ENTERPRISES , INC., BURBANK, CA (US)

(21) Appl. No.: 12/387,772

(22) Filed: May 6, 2009

(51) Int. Cl. G06Q 30/00; G06Q 99/00

(52) U.S. Cl. 705/10; 705/14.41

(57) ABSTRACT

There is provided a system and method for providing online video advertisements based on determined user tolerances. There is provided a method for use by a server to present advertisements for online videos, the method comprising streaming a first online video and a first advertisement to a client, receiving one or more responses to the streaming of the first advertisement, updating a client advertisement history with the one or more responses, beginning to stream a second online video to the client, and determining a placement including a starting time and a duration for a second advertisement during the streaming of the second online video to the client based on user tolerances determined from the client advertisement history.

### BACKGROUND OF THE INVENTION

1. Field of the Invention

The present invention relates generally to presentation of advertisements. More particularly, the present invention relates to presentation of advertisements based on user behavior.

2. Background Art

Video streaming websites are a popular online destination for many users, offering flexibility, convenience, and a vast wealth of media on demand to suit everyone's tastes. Whether users want to watch the latest episode of popular broadcast programs, recent sports events, music performances, movies, or user generated content, there's a good chance that it can be conveniently streamed from online video streaming services. With the increasing proliferation of high-speed mobile broadband and media capable smartphones, the demand for online media streaming will continually grow.

However, video streaming services cannot be provided without some expenditures in network bandwidth, storage capacity, servers, customer service, publicity, software research and development, and other expenses. With much content already available online for free, many users are reticent to adopt a pay for content model. As a compromise, many online services have adopted advertisements to cover operating costs. For many users, viewing advertisements is preferable to paying money.

Therefore, a delicate balance needs to be struck between user retention and advertisement delivery. As advertisements may be obtrusive and distracting for users who want to view the video stream without interruptions, onerous in-your-face advertising policies that test the patience of users may prompt users to give up and seek alternative entertainment sources. On the other hand, advertising policies that are too lenient and restrained may result in insufficient advertisement click-throughs and impressions, leading to a revenue shortfall for supporting a viable video streaming service.

Traditionally, this balance is determined on a global basis, by for example placing a pre-determined number and length of advertisements at pre-determined breaks during video streams. Moreover, the method of advertising, such as embedded video, overlays, surrounding banner ads, and other delivery methods are typically decided upon in advance. Unfortunately, this global delivery approach does not factor in differences between users who may react differently to different kinds of advertising approaches.

Accordingly, there is a need to overcome the drawbacks and deficiencies in the art by providing a way to effectively deliver advertisements for online video based on individual user behaviors.

### SUMMARY OF THE INVENTION

There are provided systems and methods for providing online video advertisements based on determined user tolerances, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 presents a system for providing online video advertisements based on determined user tolerances, according to one embodiment of the present invention;

FIG. 2 presents a diagram of data stores updated by a timeline of events for use by a system providing online video advertisements based on determined user tolerances, according to one embodiment of the present invention;

FIG. 3 presents a series of exemplary interfaces on a display of a client using a system for providing online video advertisements based on determined user tolerances, according to one embodiment of the present invention; and

FIG. 4 shows a flowchart describing the steps, according to one embodiment of the present invention, by which a server can present advertisements for online videos based on determined user tolerances.

### DETAILED DESCRIPTION OF THE INVENTION

The present application is directed to a system and method for providing online video advertisements based on determined user tolerances. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings.

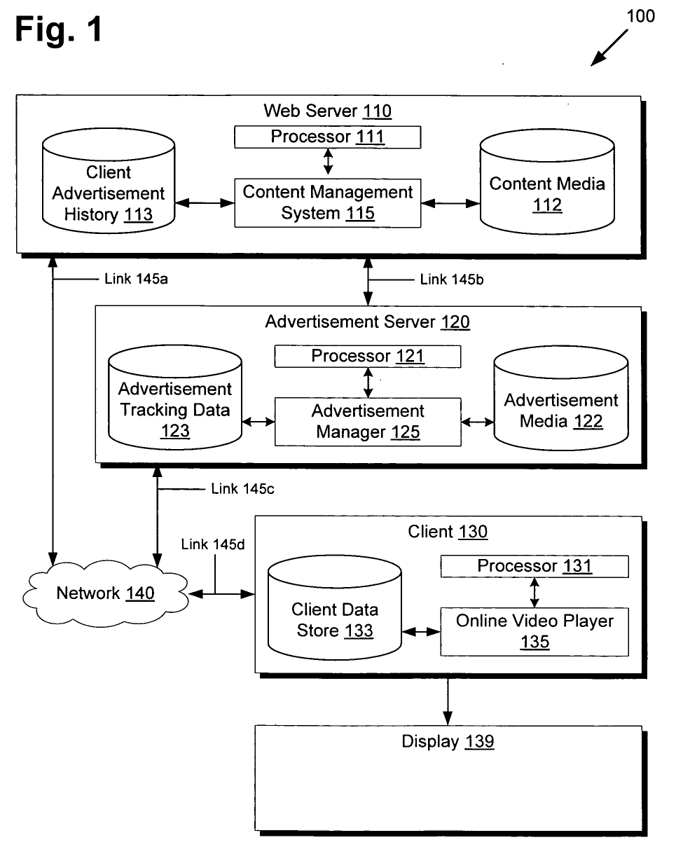

FIG. 1 presents a system for providing online video advertisements based on determined user tolerances, according to one embodiment of the present invention. Environment 100 of FIG. 1 includes web server 110, advertisement server 120, client 130, display 139, and network 140. Web server 110 includes processor 111, content media 112, client advertisement history 113, and content management system 115. Advertisement server 120 includes processor 121, advertisement media 122, advertisement tracking data 123, and advertisement manager 125. Client 130 includes processor 131, client data store 133, and online video player 135. Link 145a provides communication between web server 110 and network 140. Link 145b provides communication between web server 110 and advertisement server 120. Link 145c provides communication between advertisement server 120 and network 140. Link 145d provides communication between client 130 and network 140.

Processor 111 of web server 110 may execute content management system 115 to provide an interface for playback of video retrieved from content media 112. Content media 112 may reference a collection of video media prepared for online video streaming. This collection of video media may include long form programming such as full episodes of television series, recorded sports events, concerts, movies; short form programming such as video clips, music videos, sports highlights, user generated content; and references to live video feeds such as live events, concerts, or sporting events.

Processor 131 of client 130 may then, for example, execute a web browser to access web server 110 via network 140 to retrieve online video player 135, which may then be executed by processor 131 to interface with content management system 115, which then streams video from content media 112. As the user of client 130 interacts with web server 110, content management system 115 may update client advertisement history 113 to keep track of user reactions to advertisements, and may also communicate with advertisement server 120 to retrieve or forward advertising or to update advertising tracking data.

Processor 121 of advertisement server 120 may execute advertisement manager 125 to provide advertisement strategies for content management system 115. Advertisement tracking data 123 may comprise a data store to track globally applicable advertising metrics, such as impressions, quartiles, completes, click through counts, and other statistics. These statistics may be used to help formulate the advertising strategies, to assist in billing and invoicing, and for other purposes. Advertisement media 122 may contain advertising units in various formats and approaches, including video advertisement spots, text advertisements, animated or still frame banners, overlays, interactive widgets, bugs, fly-outs, and marquees. Once an advertisement strategy is decided, advertisement units may be selected from advertisement media 122 to be streamed to client 130 for showing on display 139 by online video player 135.

Intercommunications between web server 110, advertisement server 120, and client 130 may be provided by network 140, which may comprise a publicly accessible network such as the Internet. Although environment 100 depicts a single network 140 providing communications between web server 110, advertisement server 120, and client 130 via links 145a, 145c, and 145d, alternative network configurations may be implemented as well. For example, link 145b might be supported by an additional local intranet. Alternative embodiments may use alternative network routing configurations that still allow for intercommunications between web server 110, advertisement server 120, and client 130.

Additionally, although environment 100 of FIG. 1 depicts a single web server 110 and a single advertisement server 120, alternative embodiments may consolidate the functions of web server 110 and advertisement server 120 into a single server, or may distribute client service workloads across several web servers or several advertisement servers for load balancing, redundancy, and to apply a unified advertising approach to a family of domains.

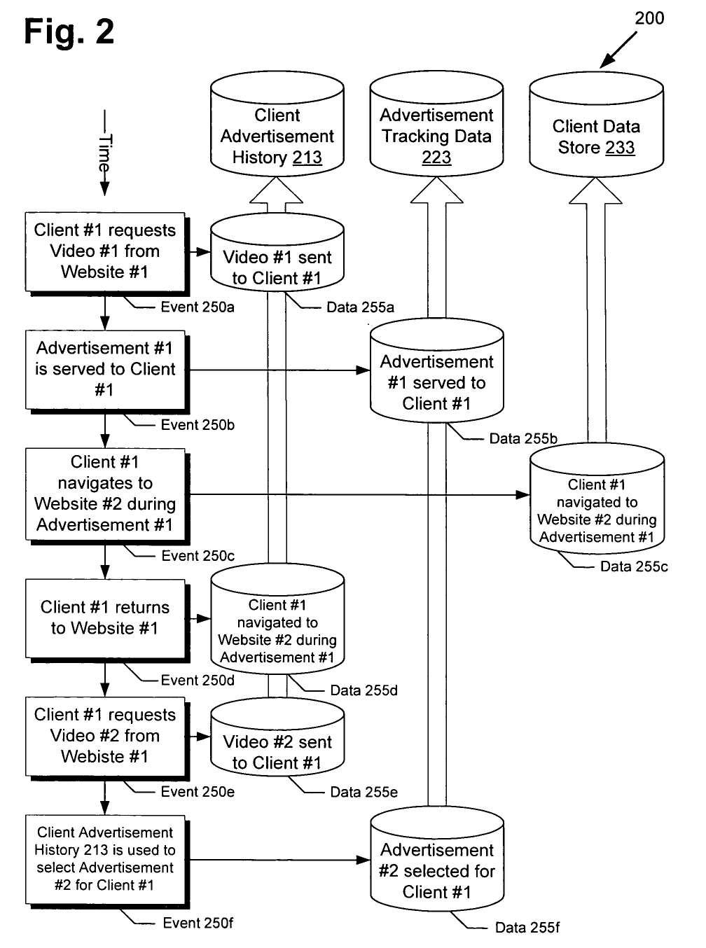

FIG. 2 presents a diagram of data stores updated by a timeline of events for use by a system providing online video advertisements based on determined user tolerances, according to one embodiment of the present invention. Diagram 200 of FIG. 2 includes client advertisement history 213, advertisement tracking data 223, client data store 233, events 250a-250f, and data 255a-255f. With regards to FIG. 2, it should be noted that client advertisement history 213 corresponds to client advertisement history 113 from FIG. 1, that advertisement tracking data 223 corresponds to advertisement tracking data 123, and that client data store 233 correspond to client data store 133.

At event 250a, “Client #1 requests Video #1 from Website #1.” Event 250a is represented by data 255a, “Video #1 sent to Client #1,” which is stored in client advertisement history 213. Examining FIG. 1, this corresponds to client 130 requesting Video #1, which may be stored within content media 112, from web server 110. Additionally, content management system 115 may generate and store data 255a into client advertisement history 113.

At event 250b, “Advertisement #1 is served to Client #1.” Event 250b is represented by data 255b, “Advertisement #1 served to Client #1,” which is stored in advertisement tracking data 223. Examining FIG. 1, this corresponds to advertisement server 120 serving Advertisement #1, which may be stored within advertisement media 122, to client 130. Advertisement server 120 may, for example, provide Advertisement #1 over network 140 via link 145b and 145a, or via link 145c.

At event 250c, “Client #1 navigates to Website #2 during Advertisement #1.” Event 250c is represented by data 255c, “Client #1 navigated to Website #2 during Advertisement #1,” which is stored in client data store 233. Data 255c may indicate what might generally be termed an abandonment response, where the client decides to do something that terminates the streaming of Video #1. In event 250c, this abandonment response happens to involve navigating to another domain, but other abandonment responses might include a network disconnection, a request to stop playback through a user interface, or a request for a different Video #3.

Data 255c may also include more detailed tracking information besides a reference to the media being streamed at the time of stream termination, such as an exact media playback position of Advertisement #1 playing on online video player 135 at the time of the abandonment response. Examining FIG. 1, this corresponds to client 130 navigating to another web server, not shown in FIG. 1, during the playback of Advertisement #1 initiated by event 250b. For example, online video player 135 may store data 255c within a Hypertext Transfer Protocol (HTTP) cookie stored in client data store 133, once online video player 135 detects that a user of client 130 has decided to navigate to an external website hosted on another domain. Since web server 110 may not have the capability to track this action in real-time, data 255c representing the navigation action can be stored in a cookie on client 130 for future use by web server 110. Besides HTTP cookies, other methods to store data 255c might also be utilized so that web server 110 can be informed of data 255c at a later time.

At event 250d, “Client #1 returns to Website #1.” Event 250d is represented by data 255d, “Client #1 navigated to Website #2 during Advertisement #1,” which is stored in client advertisement history 213. Examining FIG. 1, this corresponds to client 130 navigating back to web server 110. Since client 130 contains the cookie from event 250c in client data store 133, web server 110 can query client 130 for the updated cookie and receive data 255d, which is equal to data 255c. In turn, content management system 115 of web server 130 can store data 255d within client advertisement history 113.

At event 250e, “Client #1 requests Video #2 from Website #1.” Event 250e is represented by data 255e, “Video #2 send to Client #1,” which is stored in client advertisement history 213. Examining FIG. 1, this corresponds to client 130 requesting Video #2, which may be stored within content media 112, from web server 110. Additionally, content management system 115 may generate and store data 255e into client advertisement history 113.

At event 250f, “Client Advertisement History 213 is used to select Advertisement #2 for Client #1.” Event 250f is represented by data 255f, “Advertisement #2 selected for Client #1,” which is stored in advertisement tracking data 223. Examining FIG. 1, this corresponds to advertisement server 120 using client advertisement history 113 to select Advertisement #2, which may be stored within advertisement media 122. Advertisement server 120 may also rely on some logic provided by content management system 115 for interpreting client advertisement history 113. For example, since client advertisement history 113 contains data 255d, or that “Client #1 navigated to Website #2 during Advertisement #1,” data 255d might be used to conclude that some aspect of Advertisement #1 caused client 130 to abandon video playback from web server 110 and navigate to Website #2 instead.

This conclusion derived from client advertisement history 113 may be used, for example, to affect a user tolerance score, where the user tolerance score determines a particular advertising strategy to be utilized. Thus, advertisement server 120 might adopt a different advertising strategy for client 130, such as providing advertisements with different subject matter, advertisements with longer or shorter durations, advertisements in greater or less quantities, advertisements at different positions within media playback, advertisements using different presentation methods, and other variations. In this manner, online advertisements can be provided based on determined user tolerances, rather than a single global and inflexible standard.

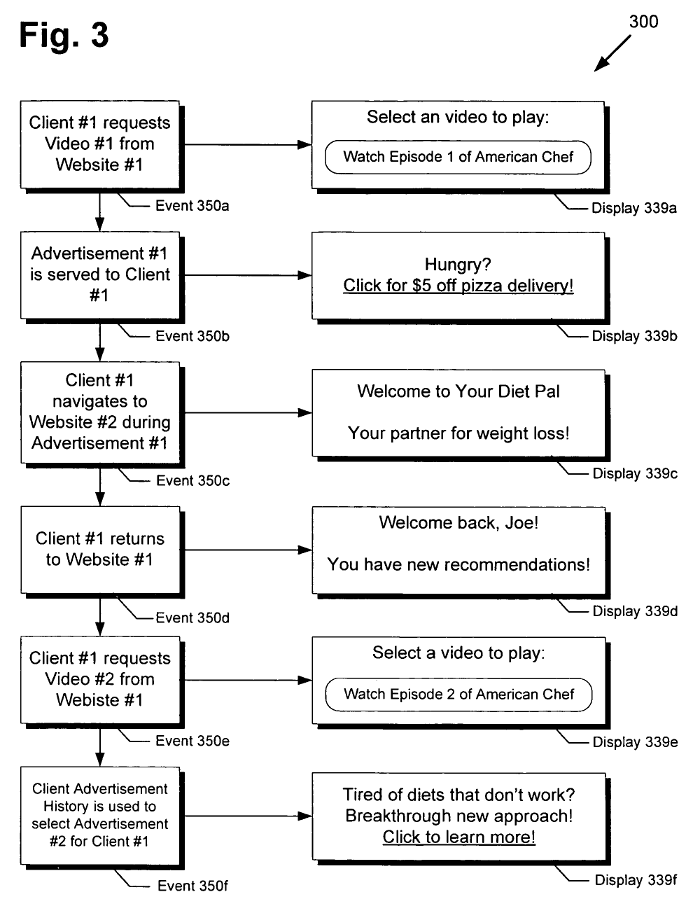

FIG. 3 presents a series of exemplary interfaces on a display of a client using a system for providing online video advertisements based on determined user tolerances, according to one embodiment of the present invention. Diagram 300 of FIG. 300 includes events 350a-350f and displays 339a-339f. With regards to FIG. 3, it should be noted that events 350a-350f correspond to events 250a-250f from FIG. 2, and that displays 339a-339f correspond to display 139 from FIG. 1.

As events 350a-350f are largely identical to events 250a-250f from FIG. 2, the contents of display 339a-339f shall be explored in greater detail. First, display 339a shows an interface where a user can select a video to stream. Examining FIG. 1, this corresponds to content management system 115 displaying the interface for client 130, which may be interpreted by a web browser for output to display 139. A user of client 130 may then click the button indicating a request to “Watch Episode 1 of American Chef.” Examining FIG. 1, event 350a comprises client 130 requesting a video corresponding to episode 1 of a program called “American Chef” from web server 10.

Next, display 339b shows Advertisement #1, which might comprise an overlay shown on top of streaming video content. As shown in display 339b, the user of Client 110 is presented a special offer for five dollars off pizza delivery. Examining FIG. 1, event 350b corresponds to advertisement server 120 selecting the pizza delivery advertisement from advertisement media 122 and streaming it to client 130 for output to display 139. Since the subject matter of the requested video program from event 350a is related to food, the advertisement for the video program might also be selected from the same food subject matter, leading to the selection of a pizza advertisement.

Next, display 339c shows content from a different Website #2, which might comprise a domain providing diet plans. As shown in display 339c, the user of Client 110 is shown a welcome screen for the domain providing diet plans. Examining FIG. 1, event 350c corresponds to client 110 navigating to another web server other than web server 110. As previously discussed with FIG. 2, the details of event 350c might be stored in a cookie in client data store 133 of client 130.

Next, display 339d shows a welcome screen for Website #1. As shown in display 339d, the user of Client 110 is recognized by name and new personalized recommendations are available to view. Examining FIG. 1, event 350d corresponds to client 110 navigating back to web server 110. Since a connection is reestablished with web server 110, web server 110 can retrieve the cookie stored from event 350c. The cookie may uniquely identify Client #1, allowing web server 110 to recognize Client #1 as “Joe” as shown by display 339d. Furthermore, through a secondary database or by other means, web server 110 may be able to discern that Website #2 is related to the subject matter of dieting.

Next, display 339e shows an interface where the user can select a recommended video to stream. Since Client #1 previously watched an episode of “American Chef,” other episodes of “American Chef” might be recommended, as shown by display 339e. Examining FIG. 1, this corresponds to content management system 115 displaying the interface for client 130, which may be interpreted by a web browser for output to display 139. A user of client 130 may then click the button indicating a request to “Watch Episode 2 of American Chef.” Examining FIG. 1, event 350e comprises client 130 requesting a video corresponding to episode 2 of the program called “American Chef” from web server 110.

Next, display 339f shows a second advertisement based on a determined user tolerance to Advertisement #1. Since Advertisement #1 was a food related advertisement, and since event 350c indicates that client 130 navigated to a dieting website during Advertisement #1, it might be concluded that using food as a subject matter for advertisements may not be a good advertisement strategy for client 130. Although in general, a population that watches food programming may be receptive to food advertisements, a subset of that population may be currently dieting and may prefer not to see food advertisements. Thus, by determining user tolerances for individual viewers rather than using a blanket advertising strategy for the entire population, individual viewers can view advertisements within their comfort zone, maximizing user retention and advertisement exposure. For example, a user tolerance for client 130 might be created, which includes an aversion for advertisements related to food as a subject matter and a preference for advertisements related to dieting. As a result, instead of continuing to provide food related advertisements, dieting advertisements might be selected instead, as shown by display 339f. As a result, instead of switching to Website #2, the dieting website, when the user of client 110 is confronted with Advertisement #2, the user may tolerate viewing Advertisement #2 in its entirety or even provide a revenue generating click through.

While FIG. 3 illustrates one specific example, the general principle of providing online video advertisements based on determined user tolerances can be used in any number of different scenarios. The example in FIG. 3 focused on subject matter, but many other criteria could be used as well. User responses to the duration, frequency, delivery method, playback position, and other advertisement properties can be tracked and advertising strategies can be adjusted accordingly. For example, a conservative advertisement strategy might be adopted first, and advertising might adjust in intensity by decreasing a time period between advertisements until a comfortable balance for the user is established. Alternatively, the duration of advertisements may progressively lengthen as the user provides more click-throughs. If a user tends to discontinue watching video content midway, then advertisements might tend to be presented at positions closer to the start of video content, where the user's attention seems to be higher. If longer advertisements tend to cause the user to disconnect but shorter advertisements are viewed and tolerated, then advertisement selection might be biased towards shorter advertising spots. In this manner, advertising strategies can dynamically change according to individual user tolerances for online video advertisements, leading to higher user retention and better click-through rates.

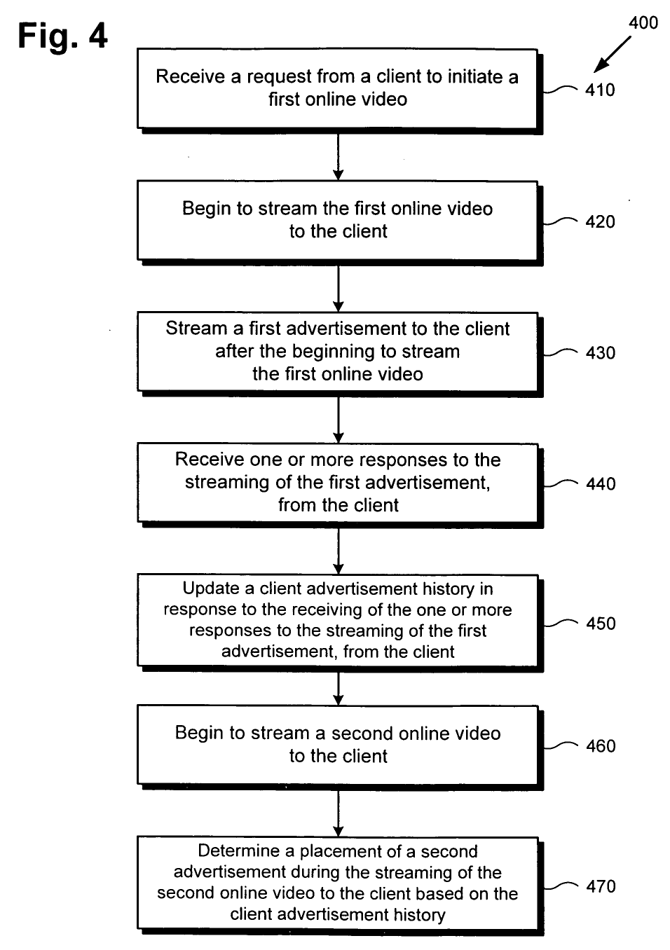

FIG. 4 shows a flowchart describing the steps, according to one embodiment of the present invention, by which a server can present advertisements for online videos based on determined user tolerances. Certain details and features have been left out of flowchart 400 that are apparent to a person of ordinary skill in the art. For example, a step may comprise one or more substeps or may involve specialized equipment or materials, as known in the art. While steps 410 through 470 indicated in flowchart 400 are sufficient to describe one embodiment of the present invention, other embodiments of the invention may utilize steps different from those shown in flowchart 400.

Referring to step 410 of flowchart 400 in FIG. 4 and environment 100 of FIG. 1, step 410 of flowchart 400 comprises processor 111 of web server 110 receiving a request from client 130 to initiate a first online video. Using the example previously used for FIG. 3, episode 1 of “American Chef” may be requested for playback on display 139 of client 130 via online video player 135.

Referring to step 420 of flowchart 400 in FIG. 4 and environment 100 of FIG. 1, step 420 of flowchart 400 comprises processor 111 of web server 110 beginning to stream episode 1 of “American Chef” to client 130. By using network 140, link 145a, and link 145d, a data stream of the content requested in step 410 can be sent to client 130.

Referring to step 430 of flowchart 400 in FIG. 4 and environment 100 of FIG. 1, step 430 of flowchart 400 comprises processor 111 of web server 110 streaming a first advertisement to client 130 after step 420. Continuing with the example used for FIG. 3, the pizza advertisement may be streamed to client 130 via network 140 and link 145d, either by link 145c or routed through web server 110 via link 145b and link 145a.

Referring to step 440 of flowchart 400 in FIG. 4 and environment 100 of FIG. 1, step 440 of flowchart 400 comprises processor 111 of web server 110 receiving one or more responses to step 430 from client 130. Continuing with the example used for FIG. 3, step 440 may include receiving data similar to data 255d from FIG. 2, or that client 130 navigated to the dieting website during step 430.

Referring to step 450 of flowchart 400 in FIG. 4 and environment 100 of FIG. 1, step 450 of flowchart 400 comprises processor 111 of web server 110 updating client advertisement history 113 in response to step 440. Thus, step 450 may deposit the data from step 440, or that client 130 navigated to the dieting website during step 430, into client advertisement history 113.

Referring to step 460 of flowchart 400 in FIG. 4 and environment 100 of FIG. 1, step 460 of flowchart 400 comprises processor 111 of web server 110 beginning to stream episode 2 of “American Chef” to client 130. Similar to step 420, by using network 140, link 145a, and link 145d, a data stream of the content requested in step 460 can be sent to client 130.

Referring to step 470 of flowchart 400 in FIG. 4 and environment 100 of FIG. 1, step 470 of flowchart 400 comprises processor 111 of web server 110 determining a placement of a second advertisement during the streaming of episode 2 of “American Chef” initiated in step 460 based on client advertisement history 113 updated in step 450. Continuing with the example used for FIG. 3, step 470 may have processor 111 concluding that the user of client 130 has an aversion to advertisements with food as a subject matter, and a preference for advertisements with dieting as a subject matter, since client 130 decided to change to a dieting website when the pizza advertisement was playing. Thus, based on client advertisement history 113, processor 111 may choose the dieting advertisement for streaming to client 130. However, as previously discussed, step 470 may also determine an advertisement placement based on other criteria besides subject matter. The placement also includes a starting time and a duration for the second advertisement, which may also be affected by parameters within client advertisement history 113.

From the above description of the invention it is manifest that various techniques can be used for implementing the concepts of the present invention without departing from its scope. Moreover, while the invention has been described with specific reference to certain embodiments, a person of ordinary skills in the art would recognize that changes can be made in form and detail without departing from the spirit and the scope of the invention. As such, the described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A method for use by a server to present advertisements for online videos, the method comprising:
receiving a request from a client to initiate a first online video;
beginning to stream the first online video to the client;
streaming a first advertisement to the client after the beginning to stream the first online video;
receiving one or more responses to the streaming of the first advertisement, from the client;
updating a client advertisement history in response to the receiving of the one or more responses to the streaming of the first advertisement, from the client;
beginning to stream a second online video to the client; and
determining a placement for a second advertisement during the streaming of the second online video to the client based on the client advertisement history, wherein the placement includes a starting time for the second advertisement after the beginning to stream the second online video and a duration of the second advertisement.

2. The method of claim 1, wherein the receiving of the one or more responses includes receiving a Hypertext Transfer Protocol (HTTP) cookie having the one or more responses from the client.

3. The method of claim 1, wherein the receiving of the one or more responses includes receiving an abandonment response indicating a termination of the streaming of the first online video.

4. The method of claim 3, wherein the abandonment response comprises a request to stop playback.

5. The method of claim 3, wherein the abandonment response comprises a request to play a third online video.

6. The method of claim 3, wherein the abandonment response comprises navigation to an external domain.

7. The method of claim 3, wherein the abandonment response includes a media playback position and a reference to a media being streamed at a time of the termination.

8. The method of claim 3, wherein the determining the placement of the second advertisement includes the starting time earlier than a starting time of the first advertisement.

9. The method of claim 3, wherein the determining the placement of the second advertisement includes the duration shorter than a duration of the first advertisement.

10. The method of claim 3, further comprising:
determining a placement for a third advertisement during the streaming of the second online video to the client based on the client advertisement history, wherein a time period between the starting time for the second advertisement and a starting time for the third advertisement is shorter than a time period not based on the client advertisement history.

11. The method of claim 3, further comprising:
determining a placement for a third advertisement during the streaming of the second online video to the client based on the client advertisement history, wherein a time period between the starting time for the second advertisement and a starting time for the third advertisement is longer than a time period not based on the client advertisement history.

12. The method of claim 3, wherein the determining the placement of the second advertisement further includes a presentation method different than a presentation method of the first advertisement.

13. The method of claim 3, wherein the determining the placement of the second advertisement further includes a subject matter different than a subject matter of the first advertisement.

14. The method of claim 1, wherein the receiving of the one or more responses includes receiving a click through for the first advertisement.

15. The method of claim 14, wherein the determining the placement of the second advertisement includes the duration longer than a duration of the first advertisement.

16. A server for presenting advertisements for online video, the server comprising:
a processor configured to:
receive a request from a client to initiate a first online video;
begin to stream the first online video to the client;
stream a first advertisement to the client after the beginning to stream the first online video;
receive one or more responses to the streaming of the first advertisement, from the client;
update a client advertisement history in response to the receiving of the one or more responses to the streaming of the first advertisement, from the client;
begin to stream a second online video to the client; and
determine a placement for a second advertisement during the streaming of the second online video to the client based on the client advertisement history, wherein the placement includes a starting time for the second advertisement after the beginning to stream the second online video and a duration of the second advertisement.

17. The server of claim 16, wherein the placement of the second advertisement includes the starting time earlier than a starting time of the first advertisement.

18. The server of claim 16, wherein the placement of the second advertisement includes the duration shorter than a duration of the first advertisement.

19. The server of claim 16, wherein the placement of the second advertisement further includes a presentation method different than a presentation method of the first advertisement.

20. The server of claim 16, wherein the placement of the second advertisement further includes a subject matter different than a subject matter of the first advertisement.
